(19) United States
(12) Patent Application Publication
(10) Pub. No.: US 2010/0071978 A1
(43) Pub. Date: Mar. 25, 2010

(54) COMBUSTION AIR CLEANER SCAVENGE SYSTEM

(75) Inventor: Brandon J. Kisse, Kindred, ND (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: Clark Equipment Company, West Fargo, ND (US)

(21) Appl. No.: 12/234,831

(22) Filed: Sep. 22, 2008

(51) Int. Cl. B60K 11/06; B01D 46/10; F01P 1/00; F02M 35/024

(52) U.S. Cl. 180/68.2; 55/383; 55/385.3; 123/41.65

(57) ABSTRACT

A work vehicle, such as a compact loader, has a cooling system including a cooling fan generating air flow to cool engine components. The fan is shown as an axial flow fan having an inlet throat in a shroud surrounding the fan. The inlet throat is under a negative or low pressure, and a duct or conduit is connected to the inlet throat and to a precleaner of an air filter assembly providing combustion air to the engine. The negative pressure in the inlet throat causes air to flow from the precleaner to the inlet throat.

### BACKGROUND OF THE DISCLOSURE

The present disclosure relates to an air cleaner scavenge system for drawing a low flow of air from a precleaner of an engine combustion air filter assembly by connecting the pre-cleaner to the low pressure side of an axial flow cooling fan used with a tool carrier, such as a compact loader.

Aspirators have been utilized for increasing the efficiency of air intake filters for engines by aspirating a selected amount of air from the precleaner section of the filter. However, in the prior art, special aspiration arrangements have been utilized for providing a vacuum or aspiration flow for the precleaner. Aspirators require several components.

Other systems used include engine exhaust aspirators that will supply a vacuum to the precleaner portion of an engine air filter. These create restrictions in the engine exhaust, raise noise levels and raise the cost of the exhaust system components.

### SUMMARY OF THE DISCLOSURE

The present disclosure relates to a scavenged precleaner section of an engine combustion intake air filter which is fluidly connected to a low pressure side of a cooling fan used for cooling engine components such as a radiator, oil cooler or the like. The cooling fan as shown is an axial flow fan mounted in a shroud, and forming a low pressure region on one side of the axial flow fan and a high pressure region on the other side. The scavenged air for the air precleaner is provided by a duct open to the low pressure side of the shroud, without any additional components. The duct bleeds a small amount of air through the precleaner to scavenge dust and dirt particles that are deposited in the bottom of the precleaner.

The present scavenge system is easy to install, highly effective, and does not adversely affect the flow of cooling air used for cooling other engine components or the engine combustion air.

### BRIEF DESCRIPTION OF THE DRAWINGS

FIG. 1 is a representation of a typical compact loader which has an air scavenge system for a combustion air precleaner made in accordance with the present disclosure;

FIG. 2 is a part schematic vertical sectional view of a rear portion of compact loader of FIG. 1 showing the air cooling system having an axial flow fan and with an opening coupled to a conduit leading to a precleaner section of an engine combustion intake air filter;

FIG. 3 is a schematic perspective view of the scavenge system for the precleaner of an engine filter according to the present disclosure; and

FIG. 4 is a schematic perspective sectional view through the air filter shown in FIG. 3.

### DETAILED DESCRIPTION OF ILLUSTRATIVE EMBODIMENTS

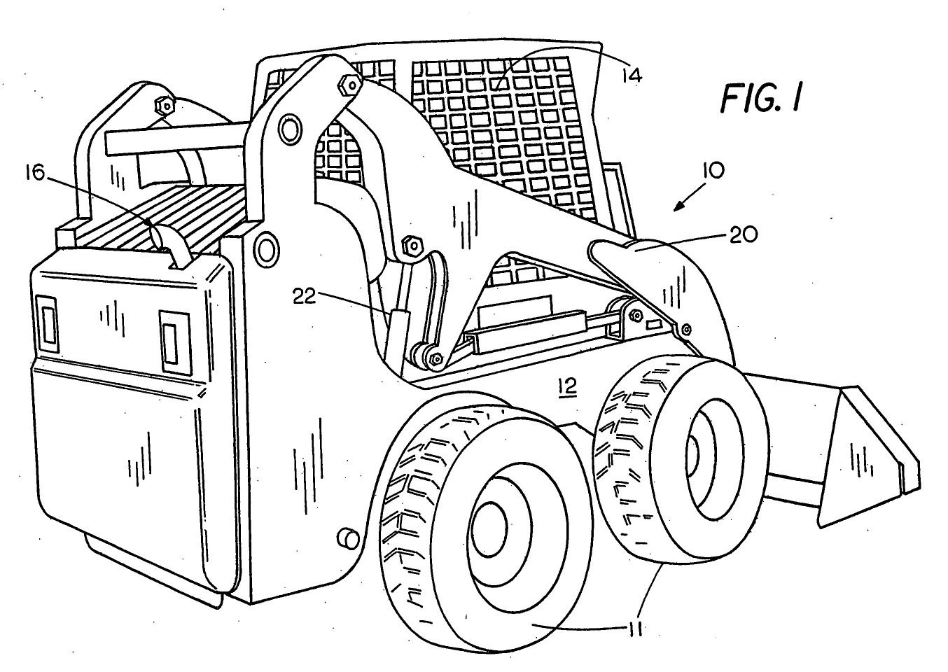

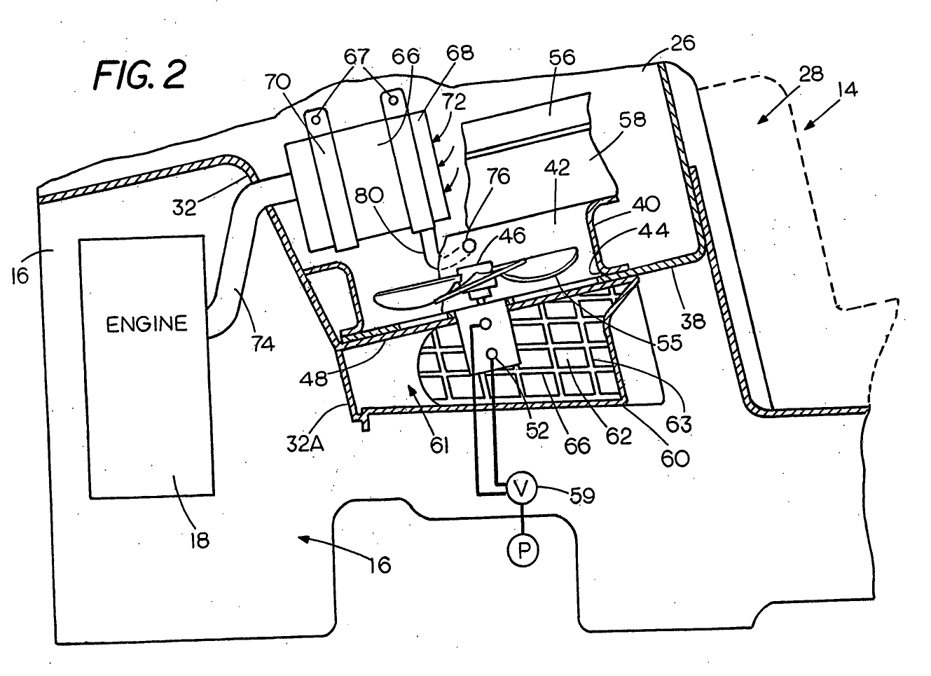

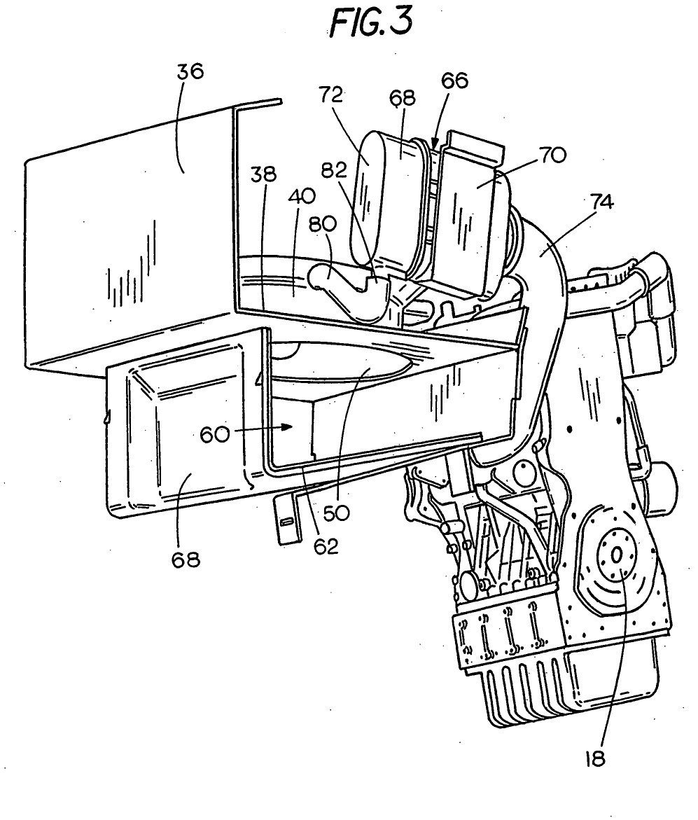

A work vehicle, shown as a compact loader indicated generally at 10 in FIG. 1 has a main frame 12 and drive wheels 11. The drive wheels are driven to move the loader in a normal manner. An operator's cab 14 is located at the forward end of the loader, and a rear engine compartment indicated in the area 16 houses an engine 18 (see FIGS. 2 and 3). The engine 18 can either be air cooled or liquid cooled and in the present disclosure a liquid cooled engine is shown. The compact loader 10 includes various hydraulic components for operating lift arms 20 using suitable hydraulic cylinders 22. The engine 18 powers hydraulic pumps to provide hydraulic fluid under pressure to power ground drive motors and the other hydraulic components.

FIG. 2 is a schematic cross section view of the engine compartment 16 and a fan and cooling system compartment 26. It can be seen that the cooling system compartment 26 is positioned in the space between the engine compartment 16 and the operator's compartment 14, which is shown schematically in FIG. 2 as a seat 28. It can thus be seen that the cooling system compartment is very close to the engine compartment and it is separated by a baffle wall 32 at the rear of the cooling system compartment.

The cooling system includes an axial flow fan assembly 46 that includes a first fan shroud 40, which is an annular shroud that has a first or inlet throat 42 and a second or exhaust throat 44. It should be noted that the throats 42 and 44 form openings to the interior of the first fan shroud 40 and comprise intake and exhaust openings. The throats are substantially the same size. The inlet throat 42 may form a venturi as shown to create a low pressure at the inlet. The axial flow fan assembly 46, has a drive motor 52 with an output shaft that drives fan blades 55.

The fan shroud is supported on a support wall 38 with suitable brackets 48, that also are used for supporting the fan drive motor 52. The axial flow fan blades 55, when rotated by a motor 52 will generate a flow of air in axial direction, and in this instance will direct air through an engine cooling radiator 58 which is shown fragmentarily on top of the throat 42, and an oil cooler 56 which is mounted on top of the radiator 58 in a normal manner. Also an air conditioning condenser and/or an intercooler or charge air cooler for cooling incoming combustion air can be provided above the first fan shroud 40.

A reversing valve 59 can be used for driving the hydraulic motor 52, in either direction of rotation. As shown, the fan blades 55 are rotated to generate an air flow into the throat 42, which is under a negative (low) pressure, and exhaust air into a second shroud or plenum 60 that receives the air flow from the fan assembly 46 when the blades 55 are rotating. Air that has passed through the radiator and other coolers provided is then discharged out through lateral side openings 62, which are covered with grates 63. One opening 62 is shown in FIG. 2. Some of the exhaust air may also be directed to the engine compartment.

The engine 18 has an engine air combustion filter 66 which, is mounted with brackets 67 in a suitable manner to a wall of the compact loader 10. The intake air filter 66 is conventional and has a precleaner housing 68, and a filter section 70. The filter section 70 has replaceable filter element 71 for filtering out fine particles. Combustion air is taken in through an end intake opening 72 of the filter 66 and after passing through the precleaner section 68 and the filter section 70, the air is discharged through a large duct or conduit 74 into the combustion air intake or turbocharger inlet of the engine, as illustrated schematically.

In order to improve the efficiency of the precleaner, a small volume of air is withdrawn from the precleaner housing or section 68. A port 76 is open through the fan shroud 40 on the low or negative pressure side of the fan blades 55 of axial flow fan assembly 46 in the throat 42, as shown in FIG. 2. As shown in FIGS. 2, 3 and 4, a conduit or line 80 is attached to the opening or port 76, and is also attached to a fitting 82 that opens through the bottom wall of the precleaner section 68, as shown in FIG. 3.

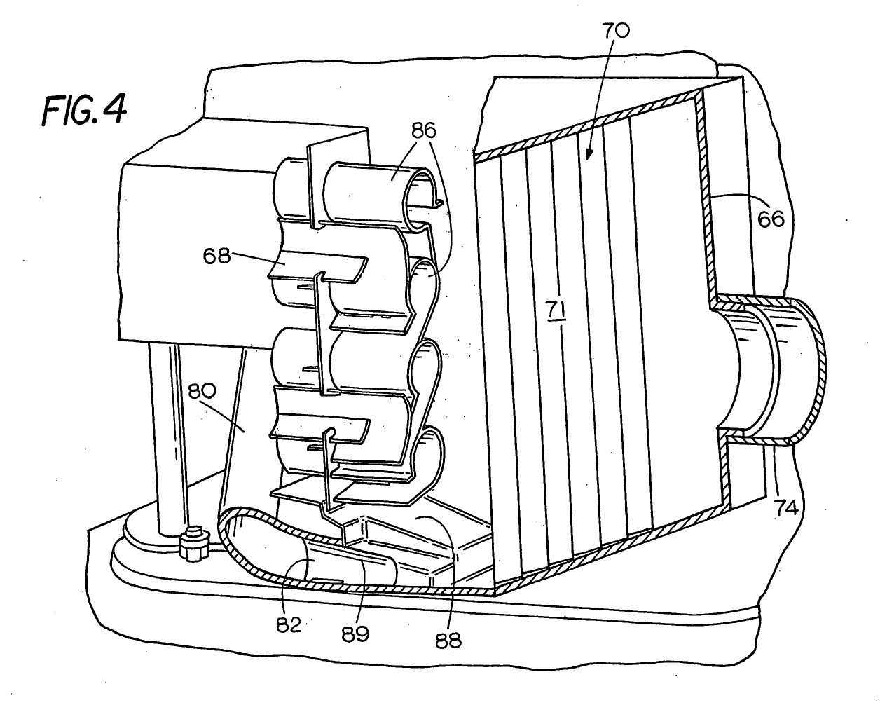

The precleaner section 68 can be designed as desired, but generally will include some baffles that will cause turbulence of the incoming air to tend to separate out larger particles of dust. FIG. 4 is a part schematic representation of one form of the intake filter. A series of turbulence causing tubes 86 receive incoming air. The dust and dirt that is separated from the incoming air in the precleaner section 68 drops down onto a lower wall 88 of the filter housing, and an opening 89 leads to the fitting 82 for the tube 80, which is providing a low vacuum to the precleaner.

The amount of air flow that is drawn from the precleaner section 68 through the scavenged air tube 80 can range as desired, and typically can be between 5% and 15% of the total air flow through the filter 66. The dirt and debris drawn from the precleaner section is discharged into second shroud 60 and out the side openings 62.

It should be noted that there is no need for any separate vacuum pump, vacuum fitting, or aspirator. The scavenge air tube 80 opens directly to the low or negative pressure side of the fan. The tube 80 is on the exterior of the fan shroud 40 and does not pass through the cooling system duct or any other ducts. The tube 80 connects easily to the negative pressure side of the axial flow fan assembly 46. Only a short length of hose is necessary for the tube 80, and the outlet tube 74 to the intake of the engine is also a short conduit.

Connecting a duct to the cooling fan negative pressure side for withdrawing scavenging air from the combustion air filter increases the life of the filter elements, by improving the precleaner efficiency and function. Increased filter life reduces machine operating cost. There only is minimal cost involved in making the connections, and in addition the present arrangement does not add to the noise from intake air flow.

All that is necessary is providing a port in the fan shroud for the axial flow fan, and connecting the port to a fitting on the precleaner section of the combustion air filter with a tube or duct 80.

Although the present invention has been described with reference to preferred embodiments, workers skilled in the art will recognize that changes may be made in form and detail without departing from the spirit and scope of the invention.

What is claimed is:

1. A work vehicle comprising an internal combustion engine:
an air filter for engine combustion air;
a precleaner for air entering the air filter to remove particles from the combustion air, the precleaner having a housing with a fitting for connection to a low pressure air source;
a cooling system for the internal combustion engine including a fan in a shroud having an inlet comprising an intake passage for incoming air and an exhaust for exhausting air; and
a conduit coupled to the intake passage and connected to the precleaner for fluid communication to draw air from the precleaner into the intake passage.

2. The work vehicle of claim 1, including a support for supporting the precleaner adjacent the shroud, and the air filter having a filtered air outlet connected to an air intake of the internal combustion engine.

3. The work vehicle of claim 1, wherein the fan comprises an axial flow fan and the intake passage comprises an inlet throat.

4. The work vehicle of claim 1, wherein the conduit between the intake passage of the shroud and the precleaner comprises a tube.

5. The work vehicle of claim 1, wherein the intake passage is coupled to draw air through at least one work vehicle cooling device.

6. The work vehicle of claim 5, wherein the work vehicle cooling device consists of at least one of an engine radiator and an oil cooler.

7. The work vehicle of claim 3, wherein air drawn through the conduit from the precleaner comprises a selected percentage of total air flow through the air filter.

8. The work vehicle of claim 7, wherein the conduit between the inlet throat and the precleaner opens to the precleaner at a lower side of the precleaner.

9. In a work vehicle having an internal combustion engine, a cooling system comprising a fan for providing cooling air across components for cooling the internal combustion engine, and an air filter for filtering incoming combustion air for the internal combustion engine, said air filter including a precleaner stage, the improvement comprising a shroud for said fan having a low pressure side and a high pressure side, and a conduit coupled between the low pressure side of the shroud and the precleaner to draw a portion of the air flowing through the precleaner into the low pressure side of the shroud.

10. The improvement of claim 9, wherein the precleaner and the filter are mounted in a single filter housing.

11. The improvement of claim 9, wherein the connection between the low pressure side of the shroud and the precleaner opens to the precleaner at a lower side of the precleaner.

12. The improvement of claim 9, wherein the cooling system is separated from the internal combustion engine by a wall, the air filter having an outlet to the internal combustion engine, and being mounted adjacent to the wall between the internal combustion engine and the cooling system.

13. The improvement of claim 9, wherein said cooling system fan comprises an axial flow fan, and the shroud surrounds the axial flow fan.

14. The improvement of claim 13 wherein the shroud forms a venturi at an inlet throat to provide the low pressure side of the shroud.
